(19) United States
(12) Patent Application Publication
(10) Pub. No.: US 2007/0123424 A1
(43) Pub. Date: May 31, 2007

(54) AQUEOUS SUSPENSION CONCENTRATES

(75) Inventors: Gerhard Frisch, Wehrheim (DE); Ulrike Ebersold, Hattersheim (DE); Janine Rude, Kriftel (DE)

Correspondence Address: FROMMER LAWRENCE & HAUG, 745 FIFTH AVENUE- 10TH FL., NEW YORK, NY, 10151, US

(73) Assignee: Bayer CropScience GmbH, Frankfurt (DE)

(21) Appl. No.: 11/562,709

(22) Filed: Nov. 22, 2006

(30) Foreign Application Priority Data
Nov. 25, 2005 (EP) 05025747.6

(51) Int. Cl. A01N 43/68

(52) U.S. Cl. 504/232

(57) ABSTRACT

The invention relates to aqueous suspension concentrates comprising (1) one or more active ingredients from the group of the 2,4-diamino-s-triazines, which are N-substituted on one amino group by a (hetero)aryl(hetero)alkyl group, (2) one or more surfactants based on nonsaltlike substituted phenol ethers, (3) one or more aluminum silicate-based thickeners, and (4) if desired, additional formulation assistants, and also (5) if desired, additional surfactants different from component (2). Besides the highly concentrated formulation of active ingredients this also allows the biological effect to be improved for the same application rate.

This application claims benefit under 35 U.S.C. 119(a) of European patent application 05025748.4, filed on 25 Nov. 2005.

Any foregoing applications, including European patent application EP 05025748.4, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The invention pertains to the technical field of formulations of active ingredients for application in crop protection. Specifically the invention relates to formulations for active ingredients containing polar groups such as amino groups and at the same time aromatic and heteroaromatic radicals.

Crop protection compositions can in principle be formulated in different ways, the properties of the active ingredients and the nature of the formulation possibly posing problems in terms of the ease of preparation, stability, ease of application, and activity of the formulations. Moreover, for reasons of economics and ecology, certain formulations are more advantageous than others. Numerous compounds from a relatively new group of 2,4-diamino-s-triazines which are N-substituted on one amino group by a (hetero)aryl(hetero)alkyl group have been disclosed as active herbicidal ingredients for controlling unwanted plant growth, such as that of weed plants in plant crops, in plantations or on noncrop land; see for example WO-A-97/08156 (U.S. Pat. No. 6,239,071), WO-A-97/31904 (U.S. Pat. No. -6,069,114), WO-A-98/15536 (U.S. Pat. No. 6,440,903), WO-A-98/15537 (US Publication 2002-016459) WO-A-98/15539 (U.S. Pat. No. 6,284,710) and also WO-A-99/65882, WO-A-00/16627, WO-A-01/43546, WO-A-03/070710 (US Publication 2004-002424), WO-A-04/069814 (US Publication 2004-069814) and literature cited in said references. The compounds differ first from the widely known 2,4-diaminotriazines of older type, such as atrazine or simazine, which are N,N′-dialkyl-substituted, in the aryl or heteroaryl groups connected to an amino group via (cyclo)aliphatic bridges, these groups being referred to here for short, together with the bridge, as (hetero)aryl(hetero)alkyl groups. They embrace arylalkyl groups and heteroarylalkyl groups which in the alkyl bridge may additionally contain heteroatoms from the group O, S, and N, it also being possible for the respective alkyl bridge to be bridged cyclically with the bridge or with the (hetero)aryl radical and hence also to form bicyclic radicals with the (hetero)aromatic. Owing to the different kind of chemical structure, these 2,4-diamino-s-triazines have different biological and physicochemical features than the aforementioned conventional 2,4-diamino-s-triazines.

For the active ingredients of the type of the aforesaid relatively new 2,4-diamino-s-triazines it is generally the case that a number of potentially possible types of formulation, such as wettable powders (WP), water-soluble powders (SP), water-soluble concentrates, emulsifiable concentrates (EC), emulsions (EW), such as oil-in-water and water-in-oil emulsions, sprayable solutions, suspension concentrates (SC), oil-based or water-based dispersions, oil-miscible solutions, capsule suspensions (CS), dusts (DP), seed-dressings, granules for broadcast and soil application, granules (GR) in the form of microgranules, spray granules, coated granules, and adsorption granules, water-dispersible granules (WG), water-soluble granules (SG), ULV formulations, microcapsules, and waxes, are specified, but in the majority of cases the only such formulations to have been set out in any greater detail among these are dusts, dispersible powders, dispersion concentrates, emulsifiable concentrates, and water-dispersible granules. See e.g. Controlled-Release Delivery Systems for Pesticides, Herbert B. Scher, Marcel Dekker, Inc. (1999) Apart from in WG formulations, the amounts of active ingredients in these formulations are generally below 25% by weight.

As well as these standard formulations there is a need generally for highly concentrated formulations of active ingredients, since such formulations are associated with a number of advantages. For example, the cost and complexity of packaging required is less than for low-concentration formulations. Correspondingly there is a resultant reduction in the cost and complexity of production, transport, and storage, and additionally the operations of preparing the spray liquors that are used in agriculture, for example, are simplified as a result of the handling of low-volume containers of crop protection compositions, such as during the operations of dispensing and of stir-mixing, for example.

The object, then, was to provide formulations, particularly for active ingredients from the group of the aforesaid relatively new 2,4-diamino-s-triazines, which have advantageous properties, such as a high—preferably better—biological action, preferably in conjunction with the possibility for a high active-ingredient concentration. Surprisingly it has been found that this object is achieved by means of the aqueous suspension concentrates of the present invention.

The invention provides an aqueous suspension concentrate comprising
(1) one or more active ingredients from the group of the 2,4-diamino-s-triazines, which are N-substituted on one amino group by a (hetero)aryl(hetero)alkyl group,
(2) one or more surfactants based on nonsaltlike substituted phenol ethers,
(3) one or more aluminum silicate-based thickeners.

The aqueous suspension concentrate of the invention may further comprise additional components, examples being:
(4) additional formulation assistants, and
(5) additional surfactants different from component (2).

Water-based formulations generally have the advantage that they require little or no organic solvent fraction.

Aqueous suspension concentrates for the formulation of active ingredients from the sectors of agrochemicals, pharmaceuticals, veterinary medicine, and also paints and varnishes are known. Thus, for example, EP-A-01 10174 (U.S. Pat. No. 4,804,399) describes aqueous suspension concentrates of crop protection agents and there are also descriptions of relatively high-concentration aqueous suspension concentrates, such as of sulfur in EP-A-0220655 and metamitron in EP-A-0620971. There a mixture of formaldehyde condensation products and/or lignosulfonates and wetting agent is preferentially utilized.

The term “aqueous suspension concentrates” refers to suspension concentrates based on water. The fraction of water in the suspension concentrates of the invention may be in general 25%-98% by weight, preferably 35%-85% by weight; the expression “% by weight” (weight percent), here and throughout the description unless otherwise defined, refers to the relative weight of the respective component based on the overall weight of the formulation.

Suitable active ingredients of the type of the aforementioned 2,4-diamino-s-triazines are the active ingredients known from the patent publications already cited, particularly 2,4-diamino-6-(halo)(cyclo)alkyl-s-triazine compounds which are substituted on one amino group by arylalkyl, heteroarylalkyl, aryloxyalkyl, heteroaryloxyalkyl, arylalkoxyalkyl, or heteroarylalkoxyalkyl radicals or by bicyclic radicals, in the latter case preferably bicyclic radicals in which the ring further from the binding site is aromatic or heteroaromatic.

Examples of suitable 2,4-diamino-s-triazines from the stated group are compounds of the formulae (I), (II), (III), and (IV) below, i.e.

1. Compounds of the formula (I) and their salts, 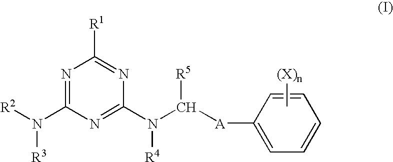
in which
R¹ is (C₁-C₆)-alkyl, which is unsubstituted or substituted by one or more radicals selected from the group consisting of halogen, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl, unsubstituted or substituted phenyl and heterocyclyl having 3 to 6 ring atoms and 1 to 3 hetero ring atoms selected from the group consisting of N, O and S, the ring being unsubstituted or substituted,
R² and R³ in each case independently of one another are hydrogen, amino or alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical or
R² and R³ together with the nitrogen atom of the group NR²R³ are a heterocyclic radical having 3 to 6 ring atoms and 1 to 4 hetero ring atoms, where the hetero ring atoms which are optionally present in addition to the nitrogen atom are selected from the group consisting of N, O and S and the radical is unsubstituted or substituted,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms, preferably having 1 to 6 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical,
R⁵ is hydrogen, halogen, nitro, cyano, thiocyanato or a radical of the formula —B¹—Y¹, where B¹ and Y¹ are as defined below,
A is an alkylene radical having 1 to 5 straight-chain carbon atoms or alkenylene or alkynylene having in each case 2 to 5 straight-chain carbon atoms, where each of the three last-mentioned diradicals is unsubstituted or substituted by one or more radicals selected from the group consisting of halogen, nitro, cyano, thiocyanato and a radical of the formula —B²—Y²,
(X)ₙ are n substituents X, where X, in each case independently of the others, is halogen, (C₁-C₆)-alkyl, (C₂-C₆)-alkenyl, (C₂-C₆)-alkynyl, (C₁-C₆)-alkoxy, (C₂-C₆)-alkenyloxy, (C₂-C₆)-alkynyloxy, [(C₁-C₄)-alkyl]-carbonyl, [(C₁-C₄)-alkoxy]-carbonyl or [(C₁-C₄)-alkylthio]-carbonyl, where the hydrocarbon-containing moieties in the 9 last-mentioned radicals are unsubstituted or substituted, or is a radical of the formula —B⁰—R⁰, where B⁰ is as defined below and R⁰ is an aromatic, saturated or partially saturated carbocyclic or heterocyclic radical, where the cyclic radical is substituted or unsubstituted,
or two adjacent radicals X together are a fused-on cycle having 4 to 6 ring atoms which is carbocyclic or contains hetero ring atoms selected from the group consisting of O, S and N and which is unsubsituted or substituted by one or more radicals selected from the group consisting of halogen, (C₁-C₄)-alkyl and oxo,
n is 0, 1, 2, 3, 4 or 5,
B⁰, B¹, B² in each case independently of one another are a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO—, —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y² in each case independently of one another are H or an acyclic hydrocarbon radical having, for example, 1 to 20 carbon atoms or a cyclic hydrocarbon radical having 3 to 8 carbon atoms or a heterocyclic radical having 3 to 9 ring atoms and 1 to 3 hetero ring atoms selected from the group consisting of N, O and S, where each of the three last-mentioned radicals is unsubstituted or substituted;

2. Compounds of the formula (II) or their salts 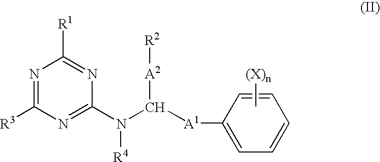
in which
R¹ is aryl, which is unsubstitued or substituted, or (C₃-C₉)-cycloalkyl, which is unsubstituted or substituted, or heterocyclyl, which is substituted or unsubstituted, or
(C₁-C₆)-alkyl, (C₂-C₆)-alkenyl or (C₂-C₆)-alkynyl,
where each of the 3 last-mentioned radicals is unsubstituted or substituted by one or more radicals selected from the group consisting of halogen, hydroxy, cyano, nitro, thiocyanato, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl and (C₃-C₉)-cycloalkyl, which is unsubstituted or substituted, and phenyl, which is unsubstituted or substituted, and heterocyclyl, which is unsubstituted or substituted, and radicals of the formulae R′—C(═Z′)—, R′—C(═Z′)-Z-, R′-Z-C(═Z′)—, R′R″N—C(═Z′)—, R′-Z-C(═Z′)-O—, R′R″N—C(═Z′)-Z-, R′—C(═Z′)-NR″— and R′R″N—C(═Z′)-NR″′—, in which R′, R″ and R″′ in each case independently of one another are (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, and in which Z and Z′ independently of one another are each an oxygen or sulfur atom,
R² is (C₃-C₉)-cycloalkyl, which is unsubstituted or substituted, (C₄-C₉)-cycloalkenyl, which is unsubstituted or substituted, heterocyclyl, which is unsubstituted or substituted, or phenyl, which is unsubstituted or substituted, or
R³ is a radical of the formula —N(B¹-D¹)(B²-D²) or —NR′—N(B¹-D¹)(B²-D²), in which in each case B¹, B², D¹ and D² are as defined below and R′ is hydrogen, (C₁-C₆)-alkyl or [(C₁-C₄)-alkyl]-carbonyl,
R⁴ is a radical of the formula —B³—D³, where B³ and D³ are as defined below,
A¹ is straight-chain alkylene having 1 to 5 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁴-D⁴, where B⁴ and D⁴ are as defined below,
A² is a direct bond or straight-chain alkylene having 1 to 4 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁵-D⁵, or a divalent radical of the formula V¹, V², V³, V⁴ or V⁵,
   —CR⁶R⁷—W*—CR⁸R⁹— (V¹)
   —CR¹⁰R¹¹—W*—CR¹²R¹³—CR¹⁴R¹⁵— (V²)
   —CR¹⁶R¹⁷—CR¹⁸R¹⁹—W*—CR²⁰R²¹— (V³)
   —CR²²R²³—CR²⁴R²⁵—W*— (V⁴)
   —CR²⁶R²⁷—W*— (V⁵)
where each of the radicals R⁶ to R²⁷, in each case independently of one another, is hydrogen, halogen, nitro, cyano, thiocyanato or a radical of the formula —B⁶-D⁶, W* is in each case an oxygen atom, a sulfur atom or a group of the formula N(B⁷-D⁷) and
B⁵, B⁶, B⁷, D⁵, D⁶ and D⁷ are as defined below,
B¹, B², B³ and B⁷ in each case independently of one another are a direct bond or a divalent group of the formulae —C(═Z*)-, —C(═Z*)-Z**-, —C(═Z*)-NH— or —C(═Z*)-NR*—, where Z*═ an oxygen or sulfur atom, Z**═ an oxygen or sulfur atom and R*═(C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted,
B⁴, B⁵ and B⁶ in each case independently of one another are a direct bond or a divalent group of the formulae —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where p is the integer 0, 1 or 2 and R^{O} is hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubsituted or substituted,
D¹, D², D³, D⁴, D⁵ D⁶ and D⁷ in each case independently of one another are hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, or in each case two radicals D⁵ of two groups —B⁵-D⁵ attached to one carbon atom are attached to one another forming an alkylene group having 2 to 4 carbon atoms which is unsubstituted or substituted by one or more radicals selected from the group consisting of (C₁-C₄)-alkyl and (C₁-C₄)-alkoxy,
(X)ₙ are n substituents X, where X, in each case independently of the others, is halogen, hydroxyl, amino, nitro, formyl, carboxyl, cyano, thiocyanato, aminocarbonyl or (C₁-C₆)-alkyl, (C₁-C₆)-alkoxy, (C₁-C₆)-alkylthio, mono-(C₁-C₆)-alkylamino, di-(C₁-C₄)-alkylamino, (C₂-C₆)-alkenyl, (C₂-C₆)-alkynyl, [(C₁-C₆)-alkyl]-carbonyl, [(C₁-C₆)-alkoxy]-carbonyl, mono-(C₁-C₆)-alkylamino-carbonyl, di-(C₁-C₄)-alkylamino-carbonyl, N-(C₁-C₆)-alkanoyl-amino or N-(C₁-C₄)-alkanoyl-N-(C₁-C₄)-alkylamino, where each of the 13 last-mentioned radicals is unsubsituted or substituted, preferably unsubstituted or substituted by one or more radicals selected from the group consisting of halogen, hydroxyl, amino, nitro, formyl, carboxyl, cyano, thiocyanato, (C₁-C₄)-alkoxy, (C₁-C₄)-haloalkoxy, (C₁-C₄)-alkylthio, (C₁-C₄)-haloalkylthio, mono-(C₁-C₄)-alkylamino, di-(C₁-C₄)-alkylamino, (C₃-C₉)-cycloalkyl, (C₃-C₉)-cycloalkyl-amino, [(C₁-C₄)-alkyl]-carbonyl, [(C₁-C₄)-alkoxy]-carbonyl, aminocarbonyl, mono-(C₁-C₄)-alkylamino-carbonyl, di-(C₁-C₄)-alkylamino-carbonyl, phenyl, phenoxy, phenylthio, phenylcarbonyl, heterocyclyl, heterocyclyloxy, heterocyclylthio and heterocyclylamino, where each of the 8 last-mentioned radicals is unsubstituted or substituted by one or more substituents selected from the group consisting of halogen, nitro, cyano, (C₁-C₄)-alkyl, (C₁-C₄)-alkoxy, (C₁-C₄)-alkylthio, (C₁-C₄)-haloalkyl, (C₁-C₄)-haloalkoxy, formyl, (C₁-C₄)-alkyl-carbonyl and (C₁-C₄)-alkoxy-carbonyl, or (C₃-C₉)-cycloalkyl, (C₃-C₉)-cycloalkoxy, (C₃-C₉)-cycloalkylamino, phenyl, phenoxy, phenylthio, phenylcarbonyl, heterocyclyl, heterocyclyloxy, heterocyclylthio or heterocyclylamino, where each of the 11 last-mentioned radicals is unsubstituted or substituted, or two adjacent radicals X together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo,
n is 0, 1, 3, 4 or 5 and
“heterocyclyl” in the radicals mentioned above, independently of the others, is in each case a heterocyclic radical having 3 to 7 ring atoms and 1 to 3 heteroatoms selected from the group consisting of N, O and S,
   where preferably
a) the total of the carbon atoms in the radicals A¹ and A²-R² is at least 6 carbon atoms or
b) the total of the carbon atoms in the radicals A¹ and A²-R² is 5 carbon atoms and A¹=a group of the formula —CH₂— or —CH₂CH₂— and R¹═(C₁-C₄)-alkyl, (C₁-C₄)-haloalkyl, (C₂-C₆)-haloalkenyl or (C₃-C₉)-cycloalkyl, which is unsubstituted or substituted;

3. Compounds of the formula (III) or their salts 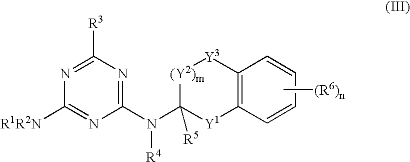
in which
R¹ and R² in each case independently of one another are hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical, heterocyclylthio radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical or
R¹ and R² together with the nitrogen atom of the group NR¹R² are a heterocyclic radical having 3 to 6 ring atoms and 1 to 4 hetero ring atoms, where any further hetero ring atoms present in addition to the nitrogen atom are selected from the group consisting of N, O and S and the radical is unsubstituted or substituted,
R³ is halogen, cyano, thiocyanato, nitro or a radical of the formula -Z¹-R⁷,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical,
R⁵ is halogen, cyano, thiocyanato, nitro or a radical of the formula -Z²-R⁸,
R⁶ in the case where n=1, or the radicals R⁶ in each case independently of one another, if n is greater than 1, are halogen, cyano, thiocyanato, nitro or a group of the formula -Z³-R⁹,
R⁷, R⁸, R⁹ in each case independently of one another are
   hydrogen or
   an acyclic hydrocarbon radical, where carbon atoms in the chain may be substituted by heteroatoms selected from the group consisting of N, O and S, or
   a cyclic hydrocarbon radical or
   a heterocyclic radical,
where each of the 3 last-mentioned radicals is unsubstituted or substituted,
Z¹, Z², Z³ in each case independently of one another are
   a direct bond or
   a divalent group of the formula —O—, —S(O)ₚ—, —S(O)ₚ—O—, —O—S(O)ₚ—, —CO—, —CS—, —S—CO—, —CO—S—, —O—CS—, —CS—O—, —S—CS—, —CS—S—, —OCO—, —CO—O—, —NR′—, —O—NR′—, —NR′—O—, —NR′—CO— or —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y², Y³ and, if m is 2, 3 or 4, further groups Y² are, in each case independently of one another,
   a divalent group of the formula CR^{a}R^{b}, where R^{a} and R^{b} are identical or different and are in each case a radical selected from the group of the radicals possible for R⁷ to R⁹, or
   a divalent group of the formula —O—, —CO—, —C(═NR^{*})—, —S(O)_{q}—, —NR^{*}— or —N(O)—, where q=0, 1 or 2 and R^{*} is hydrogen or alkyl having 1 to 4 carbon atoms, or
   Y¹ or Y³ is a direct bond,
where two oxygen atoms of groups Y² and Y³ are not adjacent,
m is 1, 2, 3 or 4,
n is 0, 1, 2, 3 or 4;

4. Substituted 2,4-diamino-1,3,5-triazines of the formula (IV), 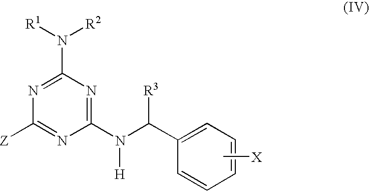
in which
R¹ is hydrogen or unsubstituted or hydroxyl-, cyano-, halogen- or (C₁-C₄)-alkoxy-substituted alkyl having 1 to 6 carbon atoms,
R² is hydrogen, formyl, in each case unsubstituted or cyano-, halo- or (C₁-C₄)-alkoxy-substituted alkyl, alkylcarbonyl, alkoxycarbonyl or alkylsulfonyl having in each case 1 to 6 carbon atoms in the alkyl groups, or is in each case unsubstituted or cyano-, halo-(C₁-C₄)-alkyl-, (C₁-C₄)-alkoxy-, halo-(C₁-C₄)-alkoxy- or (C₁-C₄)-alkoxy-carbonyl-substituted phenylcarbonyl, naphthylcarbonyl, phenylsulfonyl or naphthylsulfonyl,
R³ is unsubstituted or cyano-, halogen- or (C₁-C₄)-alkoxy-substituted alkyl having 1 to 6 carbon atoms or is unsubstituted or cyano-, halogen- or (C₁-C₄)-alkyl-substituted cycloalkyl having 3 to 6 carbon atoms,
X is a substituent selected from the group below: hydroxyl, cyano, nitro, halogen, in each case unsubstituted or hydroxyl-, cyano- or halogen-substituted alkyl or alkoxy having in each case 1 to 6 carbon atoms, in each case unsubstituted or halogen-substituted alkylcarbonyl, alkoxycarbonyl, alkylthio, alkylsulfinyl or alkylsulfonyl having in each case 1 to 6 carbon atoms in the alkyl groups, in each case unsubstituted or hydroxyl-, cyano-, nitro-, halogen-, (C₁-C₄)-alkyl, (C₁-C₄)-haloalkyl-, (C₁-C₄)-alkoxy or (C₁-C₄)-haloalkoxy-substituted phenyl or phenoxy, and
Z is hydrogen, hydroxyl, halogen, is in each case unsubstituted or hydroxyl-, cyano-, nitro-, halogen-, (C₁-C₄)-alkoxy-, (C₁-C₄)-alkyl-carbonyl-, (C₁-C₄)-alkoxy-carbonyl-, (C₁-C₄)-alkylthio-, (C₁-C₄)-alkylsulfinyl- or (C₁-C₄)-alkylsulfonyl-substituted alkyl, alkoxy, alkylcarbonyl, alkoxycarbonyl, alkylthio, alkylsulfinyl or alkylsulfonyl, having in each case 1 to 6 carbon atoms in the alkyl groups, is in each case unsubstituted or halogen-substituted alkenyl or alkynyl having in each case 2 to 6 carbon atoms or is unsubstituted or cyano-, halogen- or (C₁-C₄)-alkyl-substituted cycloalkyl having 3 to 6 carbon atoms.

Preference is given to the aforementioned 2,4-diamino-s-triazines of the formulae (I) to (V) which are substituted in position 6 on the triazine ring by radicals from the group consisting of hydrogen, (C₁-C₆)-alkyl, (C₁-C₆)-haloalkyl, (C₃-C₆)-cycloalkyl, and (C₃-C₆)-cycloalkyl-(C₁-C₄)-alkyl, preferably (C₁-C₄)-alkyl and (C₁-C₄)-haloalkyl.

Halogen-substituted alkyl (i.e., haloalkyl) is alkyl substituted by one or more halogen atoms from the group consisting of fluorine, chlorine, bromine, and iodine, preferably from the group consisting of fluorine, chlorine, and bromine, in particular from the group consisting of fluorine and chlorine.

Preference is also given to compounds of the formulae (I) to (V) in which one amino group is unsubstituted, i.e., is NH₂, and the other amino group carries a hydrogen atom and the (hetero)aryl(hetero)alkyl radical.

Preference as active ingredients is given for example to 2,4-diamino-s-triazines of the formula (Ia) 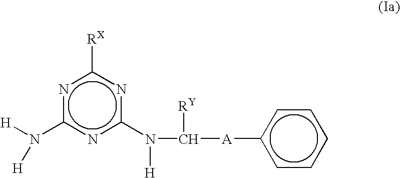
n which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl, and
A is —CH₂—, —CH₂CH₂—, —CH₂CH₂—CH₂, —O—, —CH₂—CH₂—O—, —CH₂—CH₂—CH₂—O—.

Also preferred are compounds of the formula (III) with bicyclic radicals, of the kind known from WO-A-97/31904 or WO-A-04/069814 (see Table A):

Preferred active ingredients from the group of the diaminotriazines are listed by way of example in Table A below.

TABLE A

| ID | Chemical name |
|---|---|
| A-1 | (RS)-2-Amino-4-(4-phenyl-1-cyclopropylbutylamino)-6-(1-fluoro-1- |
| | methylethyl)-1,3,5-triazine, |
| A-2 | (R)-2-Amino-4-(4-phenyl-1-cyclopropylbutylamino)-6-(1-fluoro-1- |
| | methylethyl)-1,3,5-triazine, |
| A-3 | (S)-2-Amino-4-(4-phenyl-1-cyclopropylbutylamino)-6-(1-fluoro-1- |
| | methylethyl)-1,3,5-triazine, |
| A-4 | 2-Amino-4-[(1RS)-4-phenyl-1-cyclopropylbutylamino]-6-[(1RS)-1- |
| | fluoroethyl]-1,3,5-triazine, |
| A-5 | 2-Amino-4-[(1R)-4-phenyl-1-cyclopropylbutylamino]-6-[(1RS)-1- |
| | fluoroethyl]-1,3,5-triazine, |
| A-6 | 2-Amino-4-[(1S)-4-phenyl-1-cyclopropylbutylamino]-6-[(1RS)-1- |
| | fluoroethyl]-1,3,5-triazine, |
| A-7 | 2-Amino-4-[(1R)-4-phenyl-1-cyclopropylbutylamino]-6-[(1R)-1-fluoroethyl]- |
| | 1,3,5-triazine, |
| A-8 | 2-Amino-4-[(1S)-4-phenyl-1-cyclopropylbutylamino]-6-[(1R)-1-fluoroethyl]- |
| | 1,3,5-triazine, |
| A-9 | 2-Amino-4-[(1R)-4-phenyl-1-cyclopropylbutylamino]-6-[(1S)-1-fluoroethyl]- |
| | 1,3,5-triazine, |
| A-10 | 2-Amino-4-[(1S)-4-phenyl-1-cyclopropylbutylamino]-6-[(1S)-1-fluoroethyl]- |
| | 1,3,5-triazine, |
| A-11 | (RS)-2-Amino-4-(3-phenyl-1-cyclobutylpropylamino)-6-(1-fluoro-1- |
| | methylethyl)-1,3,5-triazine, |
| A-12 | (R)-2-Amino-4-(3-phenyl-1-cyclobutylpropylamino)-6-(1-fluoro-1- |
| | methylethyl)-1,3,5-triazine, |
| A-13 | (S)-2-Amino-4-(3-phenyl-1-cyclobutylpropylamino)-6-(1-fluoro-1- |
| | methylethyl)-1,3,5-triazine, |
| A-14 | 2-Amino-4-[(1RS)-3-phenyl-1-cyclobutylpropylamino]-6-[(1RS)-1- |
| | fluoroethyl]-1,3,5-triazine, |
| A-15 | 2-Amino-4-[(1R)-3-phenyl-1-cyclobutylpropylamino]-6-[(1RS)-1- |
| | fluoroethyl]-1,3,5-triazine, |
| A-16 | 2-Amino-4-[(1S)-3-phenyl-1-cyclobutylpropylamino]-6-[(1RS)-1- |
| | fluoroethyl]-1,3,5-triazine, |
| A-17 | 2-Amino-4-[(1R)-3-phenyl-1-cyclobutylpropylamino]-6-[(1R)-1-fluoroethyl]- |
| | 1,3,5-triazine, |
| A-18 | 2-Amino-4-[(1S)-3-phenyl-1-cyclobutylpropylamino]-6-[(1R)-1-fluoroethyl]- |
| | 1,3,5-triazine, |
| A-19 | 2-Amino-4-[(1R)-3-phenyl-1-cyclobutylpropylamino]-6-[(1S)-1-fluoroethyl]- |
| | 1,3,5-triazine, |
| A-20 | 2-Amino-4-[(1S)-3-phenyl-1-cyclobutylpropylamino]-6-[(1S)-1-fluoroethyl]- |
| | 1,3,5-triazine, |
| A-21 | (RS)-2-Amino-6-(1-fluoro-1-methylethyl)-4-[1-(3,5-dimethylphenoxy)prop- |
| | 2-ylamino)-1,3,5-triazine, |
| A-22 | (R)-2-Amino-4-(3-phenyl-1-cyclobutylpropylamino)-6-(1-fluoro-1- |
| | methylethyl)-1,3,5-triazine, |
| A-23 | (S)-2-Amino-4-(3-phenyl-1-cyclobutylpropylamino)-6-(1-fluoro-1- |
| | methylethyl)-1,3,5-triazine, |
| A-24 | 2-Amino-4-[(4RS)-chroman-4-ylamino]-6-(1-fluoro-1-methylethyl)-1,3,5- |
| | triazine, |
| A-25 | 2-Amino-4-[(4R)-chroman-4-ylamino]-6-(1-fluoro-1-methylethyl)-1,3,5- |
| | triazine, |
| A-26 | 2-Amino-4-[(4R)-chroman-4-ylamino]-6-[(1RS)-1-fluoroethyl]-1,3,5- |
| | triazine, |
| A-27 | 2-Amino-4-[(4R)-chroman-4-ylamino]-6-[(1R)-1-fluoroethyl]-1,3,5-triazine, |
| A-28 | 2-Amino-4-[(4R)-chroman-4-ylamino]-6-[(1S)-1-fluoroethyl]-1,3,5-triazine, |
| A-29 | 2-Amino-4-[(4RS)-7,8-dimethylchroman-4-ylamino]-6-(1-fluoro-1- |
| | methylethyl)-1,3,5-triazine, |
| A-30 | 2-Amino-4-[(4R)-7,8-dimethylchroman-4-ylamino]-6-(1-fluoro-1- |
| | methylethyl)-1,3,5-triazine, |
| A-31 | 2-Amino-4-[(1RS)-indan-1-ylamino]-6-(1-fluoro-1-methylethyl]-1,3,5- |
| | triazine, |
| A-32 | 2-Amino-4-[(1R)-indan-1-ylamino]-6-(1-fluoro-1-methylethyl]-1,3,5-triazine, |
| A-33 | 2-Amino-4-[(1RS)-6-methylindan-1-ylamino]-6-(1-methylethyl]-1,3,5- |
| | triazine, |
| A-34 | 2-Amino-4-[(1R)-6-methylindan-1-ylamino]-6-(1-methylethyl]-1,3,5- |
| | triazine, |
| A-35 | 2-Amino-4-[(1RS)-6-fluoroindan-1-ylamino]-6-(1-fluoro-1-methylethyl]- |
| | 1,3,5-triazine, |
| A-36 | 2-Amino-4-[(1R)-6-fluoroindan-1-ylamino]-6-(1-fluoro-1-methylethyl]-1,3,5- |
| | triazine, |
| A-37 | 2-Amino-4-[(1RS,2RS)-2-methylindan-1-ylamino]-6-(1-fluoro-1- |
| | methylethyl]-1,3,5-triazine, |
| A-38 | 2-Amino-4-[(1R,2RS)-2-methylindan-1-ylamino]-6-(1-fluoro-1-methylethyl]- |
| | 1,3,5-triazine, |
| A-39 | 2-Amino-4-[(1R,2S)-2-methylindan-1-ylamino]-6-(1-fluoro-1-methylethyl]- |
| | 1,3,5-triazine, |
| A-40 | 2-Amino-4-[(1R,2R)-2-methylindan-1-ylamino]-6-(1-fluoro-1-methylethyl]- |
| | 1,3,5-triazine, |
| A-41 | 2-Amino-4-[(1RS,2RS)-2,6-dimethylindan-1-ylamino]-6-(1-fluoro-1- |
| | methylethyl]-1,3,5-triazine, |
| A-42 | 2-Amino-4-[(1R,2S)-2,6-dimethylindan-1-ylamino]-6-(1-fluoro-1- |
| | methylethyl]-1,3,5-triazine, |
| A-43 | 2-Amino-4-[(1R,2R)-2,6-dimethylindan-1-ylamino]-6-(1-fluoro-1- |
| | methylethyl]-1,3,5-triazine, |
| A-44 | 2-Amino-4-[(1RS,2RS)-6-fluoro-2-methylindan-1-ylamino]-6-(1-fluoro-1- |
| | methylethyl]-1,3,5-triazine, |
| A-45 | 2-Amino-4-[(1R,2S)-6-fluoro-2-methylindan-1-ylamino]-6-(1-fluoro-1- |
| | methylethyl]-1,3,5-triazine, |
| A-46 | 2-Amino-4-[(1R,2R)-6-fluoro-2-methylindan-1-ylamino]-6-(1-fluoro-1- |
| | methylethyl]-1,3,5-triazine, |
| A-47 | 2-Amino-4-[(1RS,2RS)-6-fluoro-2-methylindan-1-ylamino]-6-[(1RS)-1- |
| | fluoroethyl]-1,3,5-triazine, |
| A-48 | 2-Amino-4-[(1R,2S)-6-fluoro-2-methylindan-1-ylamino]-6-[(1RS)-1- |
| | fluoroethyl]-1,3,5-triazine, |
| A-49 | 2-Amino-4-[(1R,2R)-6-fluoro-2-methylindan-1-ylamino]-6-[(1RS)-1- |
| | fluoroethyl]-1,3,5-triazine, |
| A-50 | 2-Amino-4-[(1R,2S)-6-fluoro-2-methylindan-1-ylamino]-6-[(1R)-1- |
| | fluoroethyl]-1,3,5-triazine, |
| A-51 | 2-Amino-4-[(1R,2R)-6-fluoro-2-methylindan-1-ylamino]-6-[(1R)-1- |
| | fluoroethyl]-1,3,5-triazine, |
| A-52 | 2-Amino-4-[(1R,2S)-6-fluoro-2-methylindan-1-ylamino]-6-[(1S)-1- |
| | fluoroethyl]-1,3,5-triazine, |
| A-53 | 2-Amino-4-[(1R,2R)-6-fluoro-2-methylindan-1-ylamino]-6-[(1S)-1- |
| | fluoroethyl]-1,3,5-triazine, |
| A-54 | 2-Amino-4-[(1RS,2RS)-2,6-dimethylindan-1-ylamino]-6-[(1RS)-1- |
| | fluoroethyl]-1,3,5-triazine, |
| A-55 | 2-Amino-4-[(1R,2S)-2,6-dimethylindan-1-ylamino]-6-[(1RS)-1-fluoroethyl]- |
| | 1,3,5-triazine, |
| A-56 | 2-Amino-4-[(1R,2R)-2,6-dimethylindan-1-ylamino]-6-[(1RS)-1-fluoroethyl]- |
| | 1,3,5-triazine, |
| A-57 | 2-Amino-4-[(1R,2S)-2,6-dimethylindan-1-ylamino]-6-[(1R)-1-fluoroethyl]- |
| | 1,3,5-triazine, |
| A-58 | 2-Amino-4-[(1R,2R)-2,6-dimethylindan-1-ylamino]-6-[(1R)-1-fluoroethyl]- |
| | 1,3,5-triazine, |
| A-59 | 2-Amino-4-[(1R,2S)-2,6-dimethylindan-1-ylamino]-6-[(1S)-1-fluoroethyl]- |
| | 1,3,5-triazine, |
| A-60 | 2-Amino-4-[(1R,2R)-2,6-dimethylindan-1-ylamino]-6-[(1S)-1-fluoroethyl]- |
| | 1,3,5-triazine, |
| A-61 | 2-Amino-4-[(1RS)-4,6-dimethylindan-1-ylamino]-6-(1-fluoro-1- |
| | methylethyl)-1,3,5-triazine, |
| A-62 | 2-Amino-4-[(1R)-4,6-dimethylindan-1-ylamino]-6-(1-fluoro-1-methylethyl)- |
| | 1,3,5-triazine, |
| A-63 | 2-Amino-4-[(1RS)-4,6-dimethylindan-1-ylamino]-6-[(1RS)-1-fluoroethyl]- |
| | 1,3,5-triazine, |
| A-64 m | 2-Amino-4-[(1R)-4,6-dimethylindan-1-ylamino]-6-[(1RS)-1-fluoroethyl]- |
| | 1,3,5-triazine, |
| A-65 | 2-Amino-4-[(1R)-4,6-dimethylindan-1-ylamino]-6-[(1R)-1-fluoroethyl]-1,3,5- |
| | triazine, |
| A-66 | 2-Amino-4-[(1R)-4,6-dimethylindan-1-ylamino]-6-[(1S)-1-fluoroethyl]-1,3,5- |
| | triazine, |
| A-67 | 2-Amino-4-[(1RS)-5,6-dimethylindan-1-ylamino]-6-(1-fluoro-1- |
| | methylethyl)-1,3,5-triazine, |
| A-68 | 2-Amino-4-[(1R)-5,6-dimethylindan-1-ylamino]-6-(1-fluoro-1-methylethyl)- |
| | 1,3,5-triazine, |
| A-69 | 2-Amino-4-[(1RS)-5,6-dimethylindan-1-ylamino]-6-[(1RS)-1-fluoroethyl]- |
| | 1,3,5-triazine, |
| A-70 | 2-Amino-4-[(1R)-5,6-dimethylindan-1-ylamino]-6-[(1RS)-1-fluoroethyl]- |
| | 1,3,5-triazine, |
| A-71 | 2-Amino-4-[(1R)-5,6-dimethylindan-1-ylamino]-6-[(1R)-1-fluoroethyl]-1,3,5- |
| | triazine, |
| A-72 | 2-Amino-4-[(1R)-5,6-dimethylindan-1-ylamino]-6-[(1S)-1-fluoroethyl]-1,3,5- |
| | triazine, |
| A-73 | 2-Amino-4-[(1RS)-indan-1-ylamino]-1,3,5-triazine, |
| A-74 | 2-Amino-4-[(1R)-indan-1-ylamino]-1,3,5-triazine, |
| A-75 | 2-Amino-4-[(1RS)-6-methylindan-1-ylamino]-1,3,5-triazine, |
| A-76 | 2-Amino-4-[(1R)-6-methylindan-1-ylamino]-1,3,5-triazine, |
| A-77 | 2-Amino-4-[(1RS)-6-fluoroindan-1-ylamino]-1,3,5-triazine, |
| A-78 | 2-Amino-4-[(1R)-6-fluoroindan-1-ylamino]-1,3,5-triazine, |
| A-79 | 2-Amino-4-[(1RS,2RS)-2-methylindan-1-ylamino]-1,3,5-triazine, |
| A-80 | 2-Amino-4-[(1R,2S)-2-methylindan-1-ylamino]-1,3,5-triazine, |
| A-81 | 2-Amino-4-[(1R,2R)-2-methylindan-1-ylamino]-1,3,5-triazine, |
| A-82 | 2-Amino-4-[(1RS,2RS)-2,6-dimethylindan-1-ylamino]-1,3,5-triazine, |
| A-83 | 2-Amino-4-[(1R,2S)-2,6-dimethylindan-1-ylamino]-1,3,5-triazine, |
| A-84 | 2-Amino-4-[(1R,2R)-2,6-dimethylindan-1-ylamino]-1,3,5-triazine, |
| A-85 | 2-Amino-4-[(1RS)-5,6-dimethylindan-1-ylamino]-1,3,5-triazine, |
| A-86 | 2-Amino-4-[(1R)-4,6-dimethylindan-1-ylamino]-1,3,5-triazine, |
| A-87 | 2-Amino-4-[(1RS)-4,6-dimethylindan-1-ylamino]-1,3,5-triazine, |
| A-88 | 2-Amino-4-[(1R)-4,6-dimethylindan-1-ylamino]-1,3,5-triazine, |
| A-89 | 2-Amino-4-[(1RS)-5-fluoro-6-methylindan-1-ylamino]-1,3,5-triazine, |
| A-90 | 2-Amino-4-[(1R)-5-fluoro-6-methylindan-1-ylamino]-1,3,5-triazine, |
| A-91 | 2-Amino-4-[(1RS)-1,2,3,4-tetrahydronaphthalin-1-ylamino]-6-(1-fluoro-1- |
| | methylethyl)-1,3,5-triazine, |
| A-92 | 2-Amino-4-[(1R)-1,2,3,4-tetrahydronaphthalin-1-ylamino]-6-(1-fluoro-1- |
| | methylethyl)-1,3,5-triazine, |
| A-93 | 2-Amino-4-[(1RS)-1,2,3,4-tetrahydronaphthalin-1-ylamino]-6-[(1RS)-1- |
| | fluoroethyl]-1,3,5-triazine, |
| A-94 | 2-Amino-4-[(1R)-1,2,3,4-tetrahydronaphthalin-1-ylamino]-6-[(1RS)-1- |
| | fluoroethyl]-1,3,5-triazine, |
| A-95 | 2-Amino-4-[(1R)-1,2,3,4-tetrahydronaphthalin-1-ylamino]-6-[(1R)-1- |
| | fluoroethyl]-1,3,5-triazine, |
| A-96 | 2-Amino-4-[(1R)-1,2,3,4-tetrahydronaphthalin-1-ylamino]-6-[(1S)-1- |
| | fluoroethyl]-1,3,5-triazine, |
| A-97 | 2-Amino-4-[(1RS,2RS)-2-methyl-1,2,3,4-tetrahydronaphthalin-1-ylamino]- |
| | 6-(1-fluoro-1-methylethyl)-1,3,5-triazine, |
| A-98 | 2-Amino-4-[(1R,2S)-2-methyl-1,2,3,4-tetrahydronaphthalin-1-ylamino]-6- |
| | (1-fluoro-1-methylethyl)-1,3,5-triazine, |
| A-99 | 2-Amino-4-[(1R,2R)-2-methyl-1,2,3,4-tetrahydronaphthalin-1-ylamino]-6- |
| | (1-fluoro-1-methylethyl)-1,3,5-triazine, |
| A-100 | 2-Amino-4-[(1RS,2RS)-2-methyl-1,2,3,4-tetrahydronaphthalin-1-ylamino]- |
| | 6-[(1RS)-1-fluoroethyl]-1,3,5-triazine, |
| A-101 | 2-Amino-4-[(1R,2S)-2-methyl-1,2,3,4-tetrahydronaphthalin-1-ylamino]-6- |
| | [(1RS)-1-fluoroethyl]-1,3,5-triazine, |
| A-102 | 2-Amino-4-[(1R,2R)-2-methyl-1,2,3,4-tetrahydronaphthalin-1-ylamino]-6- |
| | [(1RS)-1-fluoroethyl]-1,3,5-triazine, |
| A-103 | 2-Amino-4-[(1R,2S)-2-methyl-1,2,3,4-tetrahydronaphthalin-1-ylamino]-6- |
| | [(1S)-1-fluoroethyl]-1,3,5-triazine, |
| A-104 | 2-Amino-4-[(1R,2S)-2-methyl-1,2,3,4-tetrahydronaphthalin-1-ylamino]-6- |
| | [(1R)-1-fluoroethyl]-1,3,5-triazine, |
| A-105 | 2-Amino-4-[(1R,2R)-2-methyl-1,2,3,4-tetrahydronaphthalin-1-ylamino]-6- |
| | [(1R)-1-fluoroethyl]-1,3,5-triazine, |
| A-106 | 2-Amino-4-[(1R,2R)-2-methyl-1,2,3,4-tetrahydronaphthalin-1-ylamino]-6- |
| | [(1S)-1-fluoroethyl]-1,3,5-triazine, |
| A-107 | 2-Amino-4-[(1RS)-6-methyl-1,2,3,4-tetrahydronaphthalin-1-ylamino]-6-(1- |
| | fluoro-1-methylethyl)-1,3,5-triazine, |
| A-108 | 2-Amino-4-[(1R)-6-methyl-1,2,3,4-tetrahydronaphthalin-1-ylamino]-6-(1- |
| | fluoro-1-methylethyl)-1,3,5-triazine, |
| A-109 | 2-Amino-4-[(1RS,2RS)-2,6-dimethyl-1,2,3,4-tetrahydronaphthalin-1- |
| | ylamino]-6-(1-fluoro-1-methylethyl)-1,3,5-triazine, |
| A-110 | 2-Amino-4-[(1R,2S)-2,6-dimethyl-1,2,3,4-tetrahydronaphthalin-1-ylamino]- |
| | 6-(1-fluoro-1-methylethyl)-1,3,5-triazine, |
| A-111 | 2-Amino-4-[(1RS,2R)-2,6-dimethyl-1,2,3,4-tetrahydronaphthalin-1- |
| | ylamino]-6-(1-fluoro-1-methylethyl)-1,3,5-triazine, |
| A-112 | 2-Amino-4-[(1RS)-6-methyl-1,2,3,4-tetrahydronaphthalin-1-ylamino]-6-(1- |
| | fluoro-1-methylethyl)-1,3,5-triazine, |
| A-113 | 2-Amino-4-[(1R)-6-methyl-1,2,3,4-tetrahydronaphthalin-1-ylamino]-6-(1- |
| | fluoro-1-methylethyl)-1,3,5-triazine, |
| A-114 | 2-Amino-4-[(1RS)-1,2,3,4-tetrahydronaphthalin-1-ylamino]-6-ethyl-1,3,5- |
| | triazine, |
| A-115 | 2-Amino-4-[(1R)-1,2,3,4-tetrahydronaphthalin-1-ylamino]-6-ethyl-1,3,5- |
| | triazine, |
| A-116 | 2-Amino-4-[(1RS)-6-methyl-1,2,3,4-tetrahydronaphthalin-1-ylamino]-6- |
| | ethyl-1,3,5-triazine, |
| A-117 | 2-Amino-4-[(1R)-6-methyl-1,2,3,4-tetrahydronaphthalin-1-ylamino]-6-ethyl- |
| | 1,3,5-triazine, |
| A-118 | 2-Amino-4-[(1RS)-4,6-dimethyl-1,2,3,4-tetrahydronaphthalin-1-ylamino]-6- |
| | ethyl-1,3,5-triazine, |
| A-119 | 2-Amino-4-[(1R)-4,6-dimethyl-1,2,3,4-tetrahydronaphthalin-1-ylamino]-6- |
| | ethyl-1,3,5-triazine, |
| A-120 | 2-Amino-4-[(1RS)-5-fluoro-6-methyl-1,2,3,4-tetrahydronaphthalin-1- |
| | ylamino]-6-ethyl-1,3,5-triazine, |
| A-121 | 2-Amino-4-[(1R)-5-fluoro-6-methyl-1,2,3,4-tetrahydronaphthalin-1- |
| | ylamino]-6-ethyl-1,3,5-triazine, |
| A-122 | 2-Amino-4-[(1RS)-5-fluoro-6-methyl-1,2,3,4-tetrahydronaphthalin-1- |
| | ylamino]-6-ethyl-1,3,5-triazine, |
| A-123 | 2-Amino-4-[(1R)-5-fluoro-6-methyl-1,2,3,4-tetrahydronaphthalin-1- |
| | ylamino]-6-ethyl-1,3,5-triazine, |
| A-124 | 2-Amino-4-[(1RS,2RS)-2,6-dimethyl-1,2,3,4-tetrahydronaphthalin-1- |
| | ylamino]-6-ethyl-1,3,5-triazine, |
| A-125 | 2-Amino-4-[(1R,2S)-2,6-dimethyl-1,2,3,4-tetrahydronaphthalin-1-ylamino]- |
| | 6-ethyl-1,3,5-triazine, |
| A-126 | 2-Amino-4-[(1R,2R)-2,6-dimethyl-1,2,3,4-tetrahydronaphthalin-1-ylamino]- |
| | 6-ethyl-1,3,5-triazine, |
| A-127 | 2-Amino-4-[(1RS)-1,2,3,4-tetrahydronaphthalin-1-ylamino]-1,3,5-triazine, |
| A-128 | 2-Amino-4-[(1R)-1,2,3,4-tetrahydronaphthalin-1-ylamino]-1,3,5-triazine, |
| A-129 | 2-Amino-4-[(1RS,2RS)-2-methyl-1,2,3,4-tetrahydronaphthalin-1-ylamino]- |
| | 1,3,5-triazine, |
| A-130 | 2-Amino-4-[(1R,2S)-2-methyl-1,2,3,4-tetrahydronaphthalin-1-ylamino]- |
| | 1,3,5-triazine, |
| A-131 | 2-Amino-4-[(1R,2R)-2-methyl-1,2,3,4-tetrahydronaphthalin-1-ylamino]- |
| | 1,3,5-triazine, |
| A-132 | 2-Amino-4-[(1RS,2RS)-2,6-dimethyl-1,2,3,4-tetrahydronaphthalin-1- |
| | ylamino]-1,3,5-triazine, |
| A-133 | 2-Amino-4-[(1R,2S)-2,6-dimethyl-1,2,3,4-tetrahydronaphthalin-1-ylamino]- |
| | 1,3,5-triazine, |
| A-134 | 2-Amino-4-[(1R,2R)-2,6-dimethyl-1,2,3,4-tetrahydronaphthalin-1-ylamino]- |
| | 1,3,5-triazine, |
| A-135 | 2-Amino-4-[(1RS)-5,6-dimethyl-1,2,3,4-tetrahydronaphthalin-1-ylamino]- |
| | 1,3,5-triazine, |
| A-136 | 2-Amino-4-[(1R)-5,6-dimethyl-1,2,3,4-tetrahydronaphthalin-1-ylamino]- |
| | 1,3,5-triazine, |
| A-137 | 2-Amino-4-[(1RS)-4,6-dimethyl-1,2,3,4-tetrahydronaphthalin-1-ylamino]- |
| | 1,3,5-triazine, |
| A-138 | 2-Amino-4-[(1R)-4,6-dimethyl-1,2,3,4-tetrahydronaphthalin-1-ylamino]- |
| | 1,3,5-triazine, |
| A-139 | 2-Amino-4-[(1RS)-5-fluoro-6-methyl-1,2,3,4-tetrahydronaphthalin-1- |
| | ylamino]-1,3,5-triazine, |
| A-140 | 2-Amino-4-[(1R)-5-fluoro-6-methyl-1,2,3,4-tetrahydronaphthalin-1- |
| | ylamino]-1,3,5-triazine, |

Preference is also given to salts, preferably acid addition salts, of the compounds from Table A, their hydrochlorides by way of example.

The fraction of active ingredients (component 1) in the suspension concentrates of the invention is preferably 0.1%-60% by weight, in particular 0.5%-55% by weight, more preferably 1%-50% by weight.

In one preferred embodiment of the invention the active ingredients (component 1) are present with a minimum content of 350 g of active ingredient/L, preferably 440-820 g of active ingredient/L of the overall formulation.

The surfactants (component 2) based on nonsaltlike substituted phenol ethers are, for example, nonionogenic (nonionic) monosubstituted, disubstituted, and, preferably, trisubstituted phenols, which may have been alkoxylated, e.g., ethoxylated and/or propoxylated and/or butoxylated. In this case the number of alkyleneoxy units can be in the range between 1 and 100, preferably 3-60, more preferably 5-25. Substituents on the phenol ring of the phenol derivatives are preferably styryl or isoalkyl radicals. “Styryl radical” here identifies the radical formed by aromatic substitution with styrene on the phenol, i.e., a “1-phenylethyl radical”. Examples are phenyl (C₁-C₄)-alkyl ethers or (poly)alkoxylated phenols [i.e., phenol (poly)alkylene glycol ethers], having for example 1 to 50 alkyleneoxy units in the (poly)alkyleneoxy moiety, the alkylene moiety having preferably in each case 2 to 4 carbon atoms, preferably phenol reacted with 3 to 10 mol of alkylene oxide, (poly)alkylphenols or (poly)alkylphenol alkoxylates [i.e., polyalkylphenol (poly)alkylene glycol ethers], having for example 1 to 12 carbon atoms per alkyl radical and 1 to 150 alkyleneoxy units in the polyalkyleneoxy moiety, preferably tri-n-butylphenol or triisobutylphenol reacted with 1 to 50 mol of ethylene oxide, polyarylphenols or polyarylphenol alkoxylates [i.e., polyarylphenol (poly)alkylene glycol ethers], examples being tristyrylphenol polyalkylene glycol ethers having 1 to 150 alkyleneoxy units in the polyalkyleneoxy moiety, preferably tristyrylphenol reacted with 1 to 50 mol of ethylene oxide (i.e., tristyrylphenol with 1 to 50 EO=ethyleneoxy units).

The stated nonionic surfactants may also have been modified with functional groups, phosphated or sulfated for example, but in that case must be used as component (2) in their acid form and not in the neutralized salt form. Also suitable are phosphated or sulfated nonionic surfactants in which the phosphoric acid groups or sulfate groups are fully esterified.

Preference is given to tri-[(C₁-C₄)-alkyl]-phenol alkoxylates with 1 to 30 EO or tristyrylphenol alkoxylates with 10 to 30 EO. Likewise of preferential suitability are correspondingly phosphated surfactants in the nonsaltlike (acidic) form.

Examples of surfactants of component (2) are Soprophor® 3D33 (=tristyrylphenol ethoxylated with 16 EO and phosphated), Soprophor® BSU (=tristyrylphenol ethoxylated with 16 EO), Soprophor® CY/8 (Rhodia) (=tristyrylphenol ethoxylated with 20 EO), and Hoe® S3474 (=tristyrylphenol ethoxylated with 20 EO) and in the form of the Sapogenat® T product (Clariant), such as Sapogenate T 100 (=triisobutylphenol ethoxylated with 10 EO), for example.

Examples of nonionic surfactants are also phenol reacted with 4 to 10 mol of ethylene oxide, available commercially for example in the form of the Agrisol® products (Akcros), and nonylphenol reacted with 4 to 50 mol of ethylene oxide, available commercially for example in the form of the Arkopal®) products (Clariant).

Examples of nonsaltlike surfactants are the acidic phosphoric esters of tristyrylphenol reacted with 1 to 50 mol of ethylene oxide, such as Soprophor® 3D33 or Soprophor® 4D-384 (Rhodia) or acid (linear) dodecylbenzenesulfonate, available commercially for example in the form of the Marlon® products (Hüls).

Preference for component (2) is also given to mixtures of two or more surfactants from the group of the nonsaltlike surfactants.

Preference is given in this context to mixtures of one or more of the stated nonionic surfactants; preference is also given to mixtures of one or more of the stated nonionic surfactants and one or more of the stated nonsaltlike (acidic) phosphated surfactants.

The fraction of surfactants in the suspension concentrates of the invention is generally 0.1%-20% by weight, preferably 0.5%-10% by weight, more preferably 1%-7% by weight.

Examples of suitable aluminum silicate-based thickeners (component 3) include those such as hectorites, montmorillonites, saponites, kaolinites, bentonites, attapulgites, etc.

Examples of thickeners of this kind are the Attagels® from Engelhardt Corp., such as Attagel 50, a magnesium aluminum hydrosilicate (attapulgite), or the Bentone® series from Elementis such as Bentone EW, a magnesium aluminum hydrosilicate (bentonite).

The fraction of aluminum silicate-based thickeners in the suspension concentrates of the invention is 0.01%-5% by weight, preferably 0.1%-3.5% by weight.

The thickeners of component (3) can also be used as a mixture with thickeners of another type, such as with organic thickeners such as agar-agar, carrageenan, tragacanth, gum arabic, alginates, pectins, polyoses, guar flour, carob bean flour, starch, dextrins, cellulose ethers such as carboxymethylcellulose and hydroxyethylcellulose, polyacrylic and polymethacrylic compounds, vinyl polymers, polyethers or polyamides, for example.

Examples of preferred thickeners which can be used in combination with component (3) are xanthans (heteropolysaccharides) such as the Rhodopol® products from Rhodia, an example being Rhodopol 23 (a xanthan).

It is additionally possible to add further formulation assistants to these formulations, such as defoamers, frost preventatives, preservatives, dyes or fertilizers, and surfactants different from component (2). These formulation assistants are described for example in Chemistry and Technology of Agrochemical Formulations, ed. D.A. Knowles, Kluwer Academic Publishers (1998) and Controlled-Release Delivery Systems for Pesticides, Herbert B. Scher, Marcel Dekker, Inc. (1999).

The fraction of these formulation assistants in the suspension concentrates of the invention is preferably 0.1%-22% by weight, in particular 0.5%-18% by weight, more preferably 1%-15% by weight.

Suitable defoamers include typical foam inhibitor compounds such as silicone-based defoamers, from Wacker, Rhodia or Dow Corning, for example, and acetylene-based defoamers, such as those from Air Products, for example. An example of a suitable defoamer is Rhodosil® 481 (polydimethylsiloxane and silicon) from Rhodia.

Examples of suitable frost preventatives include glycol, propylene glycol, glycerol, and urea.

Suitable preservatives are typical biocidal compounds, an example being Acticide® MBS (mixture of 1,2-benzoisothiazol-3(2H)-one and 2-methyl-2H-isothiazol-3-one, biocide) from Thor.

Examples of further surfactants different from component (2) are listed below, where EO=ethylene oxide units, PO=propylene oxide units, and BO=butylene oxide units:
1) C₁₀-C₂₄ alcohols, which may be alkoxylated, with for example 1-60 alkylene oxide units, preferably 1-60 EO and/or 1-30 PO and/or 1-15 BO in any order. The terminal hydroxyl groups of these compounds may be end-group-capped by an alkyl, cycloalkyl or acyl radical having 1-24 carbon atoms. Examples of such compounds are:
Genapol® C, L, O, T, UD, UDD, X products from Clariant, Plurafac® and Lutensol® A, AT, ON, TO products from BASF, Marlipal® 24 and 013 products from Condea, Dehypon® products from Henkel, and Ethylan® products from Akzo-Nobel such as Ethylan CD 120.
2) anionic derivatives of the products described under 1), in the form of ether carboxylates, sulfonates, sulfates, and phosphates, and their inorganic (e.g., alkali metal and alkaline earth metal) and organic salts (e.g., based on amine or alkanol amine), such as Genapol® LRO, Sandopan® products, and
Hostaphat/Hordaphos® products from Clariant.
Copolymers composed of EO, PO and/or BO units such as, for example, block copolymers such as the Pluronic® products from BASF and the Synperonic®, products from Uniqema having a molecular weight of 400 to 10⁸.
Alkylene oxide adducts of C₁-C₉ alcohols such as Atlox® 5000 from Uniqema or Hoe®-S3510 from Clariant.
3) fatty acid alkoxylates and triglyceride alkoxylates such as the Serdox® NOG products from Condea or alkoxylated vegetable oils such as soybean oil, rapeseed oil, corn germ oil, sunflower oil, cottonseed oil, linseed oil, coconut oil, palm oil, thistle oil, walnut oil, peanut oil, olive oil or castor oil, especially rapeseed oil, the vegetable oils also comprehending their transesterification products, examples being alkyl esters such as rapeseed oil methyl ester or rapeseed oil ethyl ester, examples being the Emulsogen® products from Clariant, salts of aliphatic, cycloaliphatic, and olefinic carboxylic acids and polycarboxylic acids, and also alpha-sulfo fatty acid esters of the kind obtainable from Henkel.
4) fatty acid amide alkoxylates such as the Comperlan® products from Henkel or the Amam® products from Rhodia.
   Alkylene oxide adducts of alkynediols such as the Surfynol® products from Air Products. Sugar derivatives such as amino sugars and amido sugars from Clariant, glucitols from Clariant, alkylpolyglycosides in the form of the APG® products from Henkel or such as sorbitan esters in the form of the Span® or Tween® products from Uniqema or cyclodextrin esters or ethers from Wacker.
5) surface-active cellulose derivatives and algin derivatives, pectin derivatives, and guar derivatives such as the Tylose® products from Clariant, the Manutex® products from Kelco, and guar derivatives from Cesalpina.
   Alkylene oxide adducts based on polyols, such as Polyglykol® products from Clariant.
Surface-active polyglycerides and derivatives from Clariant.
6) sulfosuccinates, alkanesulfonates, paraffinsulfonates, and olefinsulfonates such as Netzer IS®, Hoe® S1728, Hostapur® OS, Hostapur®SAS from Clariant, Triton® GR7ME and GR5 from Union Carbide, Empimine products from Albright and Wilson, and Marlon® PS65 from Condea.
7) sulfosuccinamates such as the Aerosol® products from Cytec or the Empimin® products from Albright and Wilson.
8) alkylene oxide adducts of fatty amines, quaternary ammonium compounds with 8 to 22 carbon atoms (C₈-C₂₂) such as, for example, the Genamin® C, L, O, and T products from Clariant.
9) surface-active zwitterionic compounds such as taurides, betaines, and sulfobetaines in the form of Tegotain® products from Goldschmidt, Hostapon®T and Arkopon®T products from Clariant.
10) surface-active compounds based on silicone or silane such as the Tegopren® products from Goldschmidt and the SE® products from Wacker, and also the Bevaloid®, Rhodorsil®, and Silcolapse® products from Rhodia (Dow Corning, Reliance, GE, Bayer).
11) perfluorinated or polyfluorinated surface-active compounds such as Fluowet® products from Clariant, the Bayowet® products from Bayer, the Zonyl® products from DuPont, and products of this kind from Daikin and Asahi Glass.
12) surface-active sulfonamides such as those from Bayer.
13) surface-active polyacrylic and polymethacrylic derivatives such as the Sokalan® products from BASF.
14) surface-active polyamides such as modified gelatins or derivatized polyaspartic acid from Bayer, and derivatives thereof.
15) polyvinyl-type surfactant compounds such as modified polyvinylpyrrolidone such as the Luviskol® products from BASF and the Agrimer® products from ISP or the derivatized polyvinyl acetates such as the Mowilith® products from Clariant or the corresponding butyrates such as the Lutonal® products from BASF, the Vinnapas® and the Pioloform® products from Wacker, or modified polyvinyl alcohols such as the Mowiol® products from Clariant.
16) surface-active polymers based on maleic anhydride and/or reaction products of maleic anhydride, and also copolymers containing maleic anhydride and/or reaction products of maleic anhydride, such as the Agrimer® VEMA products from ISP.
17) surface-active derivatives of montan waxes, polyethylene waxes, and polypropylene waxes, such as the Hoechst® waxes or the Licowet® products from Clariant.
18) surface-active phosphonates and phosphinates such as Fluowet® PL from Clariant.
19) polyhalogenated or perhalogenated surfactants such as, for example, Emulsogen® 1557 from Clariant.
20) anionic compounds which formally constitute the reaction products of the abovementioned phenols of component (2) with sulfuric acid or phosphoric acid and have been neutralized with suitable bases (salts), examples being the NaOH-neutralized acidic phosphoric ester of triply ethoxylated phenol, the NaOH-neutralized acidic phosphoric ester of a nonylphenol reacted with 9 mol of ethylene oxide, and the triethanolamine-neutralized phosphoric ester of the reaction product of 20 mol of ethylene oxide and 1 mol of tristyrylphenol.
21) benzenesulfonates such as alkyl- or arylbenzenesulfonates, examples being (poly)alkyl- and (poly)aryl-benzenesulfonates neutralized with appropriate bases, having for example 1 to 12 carbon atoms per alkyl radical and/or having up to 3 styrene units in the polyaryl radical, preferably (linear) dodecylbenzenesulfonates and preferably their sodium salts and/or their oil-soluble salts such as, for example, the calcium salt or the isopropylammonium salt of dodecylbenzenesulfonic acid.

Preferred among the alkyleneoxy units are 1,2-ethyleneoxy, 1,2-propyleneoxy, 1,2-butyleneoxy, and 2,3-butyleneoxy units, especially 1,2-ethyleneoxy units.

Examples of surfactants from the group of nonaromatic-based surfactants are the surfactants of aforementioned groups 1) to 19), preferably those of groups 1), 2), 6), and 8).

Examples of surfactants from the group of aromatic-based surfactants are the surfactants of the abovementioned groups 20) and 21), preferably the neutralized phosphoric esters of tristyrylphenol reacted with 1 to 50 mol of ethylene oxide, examples being those from the Soprophor® series (Rhodia) such as Soprophor® FL.

The suspension concentrates of the invention are produced in a known way (see Winnacker-Küchler, “Chemische Technologie”, volume 7, C. Hanser Verlag Munich, 4^{th} ed. 1986), such as by wet grinding of the components, for example, which can take place in appropriate mills, such as in bead mills, for example (such as batch bead mills, for example, from Drais for example, or continuous bead mills, from Bachofen, for example), or in colloid mills (such as toothed colloid mills, from Probst+Claasen, for example).

In one preferred embodiment of the invention grinding continues until 50% of the particles in the formulation have a size of less than or equal to 4 μm (d50≦4 μm).

Preferably in this case the active ingredients (component 1) in the formulation have a particle size of d50 less than or equal to 4 μm, in particular 60% or especially 80% of the active-ingredient particles have a particle size in the range from 1 to 4 μm.

In one very particularly preferred embodiment of the invention the active ingredients (component 1) in the suspension concentrate of the invention have a minimum content of 350 g of active ingredient/L, preferably 440-820 g of active ingredient/L, of the overall formulation, and additionally, after grinding, 50% of the particles of the overall formulation, preferably 50% of the particles of the active ingredients (component 1), have a size of less than or equal to 4 μm (d50≦4 μm), in particular 60%, especially 80%, of the respective particles have a size of 1 to 4 μm.

The invention further provides compositions obtainable from the suspension concentrate of the invention by dilution with liquids, preferably aqueous liquids, more preferably water.

It can be advantageous to add further active ingredients to the compositions thus obtained, preferably active agrochemical ingredients (e.g., as tank mix partners in the form of corresponding formulations) and/or auxiliaries and additives customary for the application, examples being self-emulsifying oils such as vegetable oils or liquid paraffins and/or fertilizers. The present invention accordingly further provides compositions of this kind, preferably herbicidal compositions, which are based on the suspension concentrates of the invention.

In this context the term “active agrochemical ingredients” embraces all substances which are employed in the sectors of agriculture, horticulture, forestry, and stock keeping and also in the domestic sector and in the stored-materials industry. These active agrochemical ingredients include, for example, herbicides, insecticides, acaricides, rodenticides, fungicides, bactericides, nematicides, algaecides, molluscicides, viricides, safeners, active ingredients inducing resistance to plant damage, active repellent ingredients, and active growth regulator ingredients, active ingredients with and from biological organisms, and fertilizers. Particular preference is given to active herbicidal, insecticidal, acaricidal, fungicidal, bactericidal, viricidal, and growth regulator or safener ingredients, very particular preference to herbicides, insecticides, fungicides, and safeners, and preference among these to active herbicidal ingredients.

One particular embodiment of the invention provides for the use of the compositions obtainable from the suspension concentrates of the invention for controlling unwanted plant growth, such compositions being referred to below as “herbicidal compositions”.

The herbicidal compositions exhibit excellent herbicidal activity against a broad spectrum of economically important monocotyledonous and dicotyledonous weed plants. Even difficult-to-control perennial weeds which produce shoots from rhizomes, rootstocks or other perennial organs are effectively covered. These herbicidal compositions may be applied, for example, prior to sowing, pre-emergence or post-emergence. By way of example a number of representatives may be listed among the monocotyledonous and dicotyledonous weed flora which can be controlled by the herbicidal compositions, without such naming being intended to constitute any restriction to particular species.

Among the monocot weed species those controlled effectively include, for example, Apera spica venti, Avena spp., Alopecurus spp., Brachiaria spp., Digitaria spp., Lolium spp., Echinochloa spp., Panicum spp., Phalaris spp., Poa spp., Setaria spp., and Bromus spp. such as Bromus catharticus, Bromus secalinus, Bromus erectus, Bromus tectorum, and Bromus japonicus, and Cyperus species, from the annual group, and, among the perennial species, Agropyron, Cynodon, Imperata, and Sorghum, and also perennial Cyperus species.

In the case of dicot weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp., and Viola spp., Xanthium spp., among the annuals, and also Convolvulus, Cirsium, Rumex and Artemisia among the perennial weeds.

Weed plants which occur in rice under the specific culture conditions, such as Echinochloa, Sagittaria, Alisma, Eleocharis, Scirpus, and Cyperus, are likewise controlled to outstanding effect by the herbicidal compositions.

Where the herbicidal compositions are applied to the soil surface prior to germination, then either emergence of the weed seedlings is prevented completely, or the weeds grow until they have reached the cotyledon stage, but their growth then comes to a standstill and, after three to four weeks have elapsed, they die off completely.

When the herbicidal compositions are applied post-emergence to the green parts of plants there is likewise a drastic arrest in growth very soon after the treatment, and the weeds remain at the growth stage they were in at the time of application, or die off completely after a certain time, so that in this way competition by the weeds, which is detrimental to the crop plants, is eliminated at a very early stage and in a sustained manner.

The herbicidal compositions are notable for a herbicidal action with a fast onset and long duration. The rain resistance of the active ingredients in the herbicidal compositions is generally favorable. A particular advantage is that the levels of herbicidal compounds that are active and are used in the herbicidal compositions can be made so low that their soil effect is at an optimally low level. Hence not only does it become possible to use them in sensitive crops, but also groundwater contamination is almost completely ruled out. The inventive combination of active ingredients allows a considerable reduction in the required application rate of the active ingredients.

The stated properties and advantages are beneficial in practical weed control in order to keep agricultural crops free of unwanted competitor plants and hence to secure and/or increase the yields in terms of quality and quantity. With regard to the properties described, these new herbicidal compositions significantly surpass the technical standard.

Although the herbicidal compositions display excellent herbicidal activity against monocot and dicot weeds, crop plants of economic importance, examples being dicotyledonous crops such as soybean, cotton, oil seed rape, sugar beet, or gramineous crops such as wheat, barley, rye, oats, millet, rice or maize, or, preferably, plantation crops, are damaged either only to an insignificant extent or not at all. For these reasons the present herbicidal compositions are especially suitable for the selective control of unwanted plant growth in stands of agricultural crop plants or ornamentals.

Furthermore, the corresponding herbicidal compositions exhibit outstanding growth regulator properties in crop plants. They exert regulatory intervention in the plants' own metabolism and can therefore be employed to exert a controlled influence on plant constituents and to facilitate harvesting, such as by initiating desiccation and stunting of growth, for example. They are also suitable, moreover, for the general control and inhibition of unwanted vegetative growth, without killing off the plants. The inhibition of vegetative growth plays an important part in numerous monocot and dicot crops, since it allows lodging to be reduced or prevented completely.

On the basis of their herbicidal and plant growth regulator properties, the herbicidal compositions can also be used for controlling weed plants in crops of genetically modified plants which are known or are yet to be developed. As a general rule the transgenic plants are distinguished by particular advantageous properties, such as by resistance to certain pesticides, especially certain herbicides, resistances to plant diseases or plant-disease pathogens, such as certain insects or microorganisms such as fungi, bacteria or viruses. Other particular properties relate for example to the harvested material, in terms of quantity, quality, storage properties, composition, and specific constituents. For instance, transgenic plants are known which feature increased starch content or modified quality of starch, or whose fatty acid composition in the harvested material is different.

Preference is given to the use of the herbicidal compositions in economically significant transgenic cultures of crop plants and ornamentals, such as of gramineous cultures such as wheat, barley, rye, oats, millet, rice, and maize, or else crops of sugar beet, cotton, soybeans, oil seed rape, potato, tomato, pea, and other vegetables. The herbicidal compositions can be used with preference in crops which are resistant or have been made genetically resistant to the phytotoxic effects of the herbicides.

When the herbicidal compositions are employed in transgenic crops, effects are frequently apparent—in addition to the effects on weed plants that are observed in other crops—that are specific to application in the particular transgenic crop: for example, a modified or specifically widened controllable weed spectrum, modified application rates which can be used for application, preferably effective capacity for combination with the further active herbicidal ingredients to which the transgenic crop is resistant, and also influencing of growth and yield of the transgenic crop plants.

The present invention hence further provides a method of controlling unwanted plant growth, preferably in plant crops such as cereals (e.g., wheat, barley, rye, oats, rice, maize, millet), sugar beet, sugarcane, oil seed rape, cotton, and soybeans, more preferably in monocotyledonous crops such as cereals, e.g., wheat, barley, rye, oats, hybrids thereof, such as triticale, rice, maize, and millet, which comprises applying the herbicidal compositions of the invention to the weed plants, plant parts, plant seeds or the area on which the plants are growing, e.g., the area under cultivation.

The invention additionally provides a method of controlling unwanted plant growth in plantation crops which comprises applying the herbicidal compositions of the invention to the weed plants, plant parts, plant seeds or the area on which the plants are growing, e.g., the area under cultivation.

The plant crops can also be genetically modified or a product of mutation selection, and are preferably tolerant toward acetolactate synthase (ALS) inhibitors (see, for example, EP-A-0257993, U.S. Pat. No. 5,013,659) or glyphosate herbicides (see WO 92/00377, U.S. Pat. No. 5,463,175) or gluphosinate herbicides (see EP-A-0242236, EP-A-242246, U.S. Pat. No. 5,432,971).

With the suspension concentrates of the invention it is generally possible to achieve a better biological effect for the same application rate.

Besides this the high-concentration formulation of active ingredients in the suspension concentrates of the invention permits the associated advantages, such as a lower level of packaging, as a result of which the cost and complexity involved in producing, transporting, and storing is simplified and the preparation of the spray liquors used in agriculture can be managed more effectively as a result of the smaller quantities, such as in the context of dispensing operations and stir-mixing operations, for example.

The suspension concentrates of the invention additionally surprisingly display outstanding dispersing and stabilizing properties following further dilution with liquids, preferably water.

Additionally the suspension concentrates of the invention produce formulations which are stable on storage (for long periods) and have impeccable performance properties.

The invention is further described by the following non-limiting examples which further illustrate the invention, and are not intended to, nor should they be interpreted to, limit the scope of the invention.

### EXAMPLES

1. Production:

Water is charged to a vessel and pumped in circulation via a colloid mill. Thickeners (e.g., Attagel®; Bentone®; Rhodopol®) and, where appropriate, formulation assistants, such as frost preventatives (e.g., propylene glycol) and/or preservatives (e.g. Acticide®), are added, followed by the surfactants with auxiliaries (e.g., Soprophor®, Rhodorsil®). The last component added is the active ingredient. Thereafter the mixture as a whole is transferred via the colloid mill to a further vessel. This mixture is then wet-ground using bead mills.

2. Compositions:

TABLE I
Formulation Examples 1-7

| | Example: | | | | | | |
|---|---|---|---|---|---|---|---|
| | 1 | 2 | 3 | 4 | 5 | 6 | 7 |
| Active ingredient*) | 45.45 | 50 | 52 | 55 | 56.85 | 57 | 57 |
| Attagel ® 50 | — | — | — | 0.4 | — | 0.1 | — |
| Bentone ® EW | 0.1 | 0.2 | 0.3 | 0.2 | 0.1 | 0.3 | 0.1 |
| Rhodopol ® 23 | 0.2 | 0.13 | — | — | 0.15 | — | 0.15 |
| Acticide ® MBS | 0.2 | 0.1 | — | — | 0.1 | — | 0.1 |
| Propylene glycol | 8 | — | — | — | — | — | — |
| Soprophor ® BSU | 2.1 | 2 | 2.1 | 2.2 | 2.1 | 2.5 | 2.2 |
| Soprophor ® 3D33 | 1.1 | 1 | 1 | 1 | 1 | 1 | 1 |
| Soprophor ® CY/8 | 0.5 | 0.4 | 0.4 | 0.4 | 0.4 | 0.5 | 0.4 |
| Rhodorsil ® 481 | 0.5 | — | — | — | — | — | — |
| Water | ad 100 | ad 100 | ad 100 | ad 100 | ad 100 | ad 100 | ad 100 |

All amounts in % by weight;
*)active ingredient: compound from Table A (A-1 to A-140)

3. Biological Comparative Experiments:

The suspension concentrates of the invention listed in Table I have the desired properties. Table II shows the effect of the suspension concentrates of the invention on a variety of weeds in comparison with a standard formulation (wettable powder, WP) for the same applied concentration. Table III contains a comparison of the weed action of suspension concentrates of the invention with regard to the average size of the formulation particles.

3.1 Experimental Procedure

Pre-emergence experiments with different weed types (growth stage: 00) in loamy sand or clayey silt in plastic pots (10 cm diameter) under glass (irrigation: 300 L water/ha); uniform metering of the active ingredient with 800 mg of active substance/ha; 1^{st} rating: 2 weeks after treatment, 2^{nd} rating: 4 weeks after treatment; rating values: 0 (no weed control)—100 (complete weed control).

3.2 Results of Experimentation

TABLE II
Effect of different types of formulation

| | Standard formulation*) | | Suspension concentrate | |
|---|---|---|---|---|
| Weed name/ | (state of the art) | | (Example 1 from Table I) | |
| EPPO plant code | 1^{st} rating | 2^{nd} rating | 1^{st} rating | 2^{nd} rating |
| Euphorbia spec./EPHHL | 25 | 40 | 45 | 50 |
| Solanum nigrum/SOLNI | 75 | 88 | 100 | 100 |
| Poligono convolvolo/POLCO | 40 | 40 | 80 | 84 |
| Kochia scoparia/KCHSC | 40 | 60 | 60 | 78 |
| Chenopodium album/CHEAL | 70 | 70 | 10 | 100 |
| Bidens spec./BIDPI | 0 | 0 | 40 | 10 |
| Ambrosia spec./AMBEL | 0 | 10 | 75 | 70 |
| Amaranthus retroflexus/AMARE | 55 | 55 | 95 | 97 |
| Abutilon spec./ABUTH | 10 | 15 | 35 | 35 |
| Sorghum halepense/SORHA | 35 | 78 | 98 | 100 |
| Setaria viridis/SETVI | 10 | 58 | 100 | 100 |
| Setaria faberi/SETFA | 10 | 73 | 99 | 100 |
| Echinochloa crus-galli/ECHCG | 60 | 73 | 99 | 99 |
| Digitaria sanguinalis/DIGSA | 78 | 83 | 99 | 100 |
| Brachiaria spec./BRAPP | 30 | 50 | 90 | 98 |

*)Composition: standard formulation (wettable powder, WP): 20% by weight active ingredient of the suspension concentrate (compound from Table A: A-1 to A-140), 10% by weight of Baykanol ® SL (formaldehyde-ditolyl ether sulfonate condensate), 10% by weight of Sipernat ® 22S (precipitated silica), 4% by weight of Galoryl ® MT804 (Na dibutylnaphthalenesulfonate), 56% by weight of Kaolin ® W.

TABLE III
Effect of different particle sizes

| | Suspension concentrate (Example 1 from Table I) | | | |
|---|---|---|---|---|
| | Average particle size less | | Average particle size | |
| | than 4 μm | | greater than 4 μm | |
| Weed name/ | [d50 = 3.4 μm]*) | | [d50 = 8.6 μm]*) | |
| EPPO plant code | 1^{st} rating | 2^{nd} rating | 1^{st} rating | 2^{nd} rating |
| Chenopodium album/CHEAL | 100 | 100 | 84 | 83 |
| Amaranthus retroflexus/AMARE | 88 | 100 | 65 | 53 |
| Sorghum halepense/SORHA | 97 | 99 | 58 | 89 |
| Setaria faberi/SETFA | 97 | 98 | 83 | 95 |
| Digitaria sanguinalis/DIGSA | 100 | 100 | 75 | 80 |
| Brachiaria spec./BRAPP | 92 | 98 | 80 | 74 |

*)d50 = mean diameter of the particles of the entire formulation after grinding

3.3 Discussion of the Results

As is clearly apparent from Table II, the suspension concentrates of the invention bring about a marked improvement in biological action for a given application dose than the standard formulation of the state of the art.

From the data in Table III it is apparent that a particle size which is on average relatively small, less than 4 μm, leads to a further increase in action for the suspension concentrates of the invention.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. An aqueous suspension concentrate comprising
(1) one or more active ingredients from the group of the 2,4-diamino-s-triazines, which are N-substituted on one amino group by a (hetero)aryl(hetero)alkyl group,
(2) one or more surfactants based on nonsaltlike substituted phenol ethers,
(3) one or more aluminum silicate-based thickeners.

2. The suspension concentrate as claimed in claim 1, characterized by further comprising additional formulation assistants (component 4).

3. The suspension concentrate as claimed in claim 1, characterized by further comprising additional surfactants (component 5) different from component (2).

4. The suspension concentrate as claimed in claim 1, wherein the active ingredients (component 1) have a minimum content of 350 g active ingredient/L of the overall suspension concentrate.

5. The suspension concentrate as claimed in claim 1, wherein 50% of the particles of the suspension concentrate have a size of less than or equal to 4 μm.

6. A suspension concentrate as claimed in claim 4, wherein 50% of the particles of the suspension concentrate have a particle size of less than or equal to 4 μm.

7. A method of producing a suspension concentrate as claimed in claim 1, wherein the components are wet-ground.

8. A composition obtainable from a suspension concentrate as claimed in claim 1, by dilution with liquids.

9. A method of controlling unwanted plant growth, which comprises applying a suspension concentrate as claimed in claim 1, optionally after dilution with liquids, to the weed plants, plant parts, plant seeds or the area on which the plants are growing.

10. A method as claimed in claim 9, wherein the active ingredients (component 1) are present in a minimum content of 350 g active ingredient per liter of the suspension concentrate.

11. A method as claimed in claim 9, wherein 50% of the particles of the suspension concentrate have a particle size of less than or equal to 4 μm.

12. A method as claimed in claim 10, wherein 50% of the particles of the suspension concentrate have a particle size of less than or equal to 4 μm.
